(19) United States
(12) Patent Application Publication
(10) Pub. No.: US 2003/0008559 A1
(43) Pub. Date: Jan. 9, 2003

(54) Electric shielding apparatus with a generally concentric frame

(76) Inventors: Fabrice Govin, Corbevoie (FR); Frederic Sage, Rambouillet Cedix (FR)

Correspondence Address: Morrison & Foerster LLP, Suite 300, 1650 Tysons Boulevard, McLean, VA, 22102, US

(21) Appl. No.: 10/141,767

(22) Filed: May 10, 2002

(30) Foreign Application Priority Data
May 12, 2001 (EP) 01111624.1

(51) Int. Cl. H01R 13/648

(52) U.S. Cl. 439/607

(57) ABSTRACT

An electric shielding apparatus comprises a main shielding enclosure structure and a generally concentric frame joined thereto. Cooperatively they form an electromagnetic radiation shield between an inside electric conductor and an outside space, and are furthermore arranged for mating to an external coaxial conductor viz á viz the concentric frame. In particular, the concentric frame is extrusion-formed from and constitutes a structurally unity with the main shielding enclosure.

### TECHNICAL FIELD OF THE INVENTION

The invention relates to an electric shielding apparatus, and in particular, to an electric shielding apparatus having a main shielding enclosure structure and a generally concentric frame joined thereto that cooperatively form an electromagnetic radiation shield between an inside electric conductor and an outside space.

### BACKGROUND OF THE INVENTION

High-frequency, low signal amplitude apparatuses have been using electric shielding arrangements to allow handling of electrical signals without electromagnetic interference from outside that could be fatal for correct measuring, amplifying, digitizing, and various other signal processing operations. The electric conductor will pass through the concentric frame and may outside fulfill various functions such as that of a high-frequency antenna. The transition from the well-shielded enclosure at the end of the concentric frame must be particularly well-designed, inasmuch as the latter will have to mate to the further shielding of the conductor that may be in the form of a pluggable cable.

The state of the art has manufactured the concentric frame as a mechanically separate item that is being soldered on the above main shielding. The present inventors have recognized such construction as a cause of extra costs as well as manufacturing faults. The manufacturing required the separate handling of two mechanical parts, the careful relative positioning thereof, and finally the applying of an interconnection such as by soldering. This represents an additional processing step imposing a fully different set of requirements from the mechanical forming of the two parts of the shield. The flow of solder and possibly associated soldering fluid, the application and removal of heat, and various other aspects of such soldering have been felt as causing inappropriate problems for producing a product that by itself is fully based on forming a rigid mechanical structure.

EP Published Patent Application 0 878 871 A1 corresponding to U.S. patent application Ser. No. 09/854,737 with a priority of May 12, 1997 discloses a female coax plug insulator that has a specific shape for controlling its electrical impedance and minimizing its Voltage Standing Wave Ratio. No details are being given regarding the manner of manufacturing the rigid metal parts thereof, other than by their mere dimensions, and in consequence, forming these by extrusion could have been an appropriate choice. However, the reference only relates to a substantially concentric arrangement, which does therefore not allow the shielding of a rather large electronic circuitry such as a printed circuit board like the present invention.

U.S. Pat. No. 6,042,421 discloses a male coaxial connector that has both a rigid outer structure and flexible inside tongs for securing the position of its central connector pin. Similar to the foregoing reference, no details were given on the manner of manufacturing the rigid metal parts thereof, other than their mere dimensions. Again as before, no combination with a main shielding enclosure for an electronic device has been disclosed.

U.S. Pat. No. 6,120,306 discloses a cast coax header/socket connector system, cf. in particular, column 2, line 15 and column 3, line 47. The construction disclosed has been optimized for minimum crosstalk amongst a plurality of parallel lines arranged in said connector. Moreover, the art of designing multiwire connectors is approaching its goals from a side that is completely different from the present invention. Generally, the dimensioning of a multi-wire connector, and such an electric shielding structure according to the present invention are different.

### SUMMARY OF THE INVENTION

The present invention aimins to structurally join in a single piece of work a main, relatively thin, electric shielding structure that has a substantial area for shielding an electronic device, with a generally concentric frame for therein allowing to locate an electrical conductor.

The present invention also obviates the need for soldering while upholding the shielding quality and structural integrity of the shielding arrangement.

According to one embodiment of the invention, a main shielding enclosure structure and a generally concentric frame joined thereto cooperatively form an electromagnetic radiation shield between an inside electric conductor and an outside space. The structure is arranged for mating to an external coaxial conductor viz a viz the concentric frame. The concentric frame is extrusion-formed from and constitutes a structurally unity with said main shielding enclosure.

Another embodiment of the invention discloses a shielding enclosure comprising an electric shielding arrangement, forming a first single-sided cover that is to be mated with a second single-sided cover and to an electronic apparatus arranged in a double-sided cover so constituted.

### BRIEF DESCRIPTION OF THE DRAWINGS

The invention will be discussed in detail hereinafter with reference to the disclosure of preferred embodiments, and in particular with reference to the appended Figures in which:

FIG. 1 shows a soldered version of the shielding arrangement according to prior art.

FIG. 2 shows an extruded version of the shielding arrangement of the present invention.

FIG. 3 shows an “outside” view of the shielding arrangement of the present invention.

FIG. 4 shows an “inside” view of the shielding arrangement of the present invention.

### DETAILED DESCRIPTION OF THE PREFERRED EMBODIMENTS

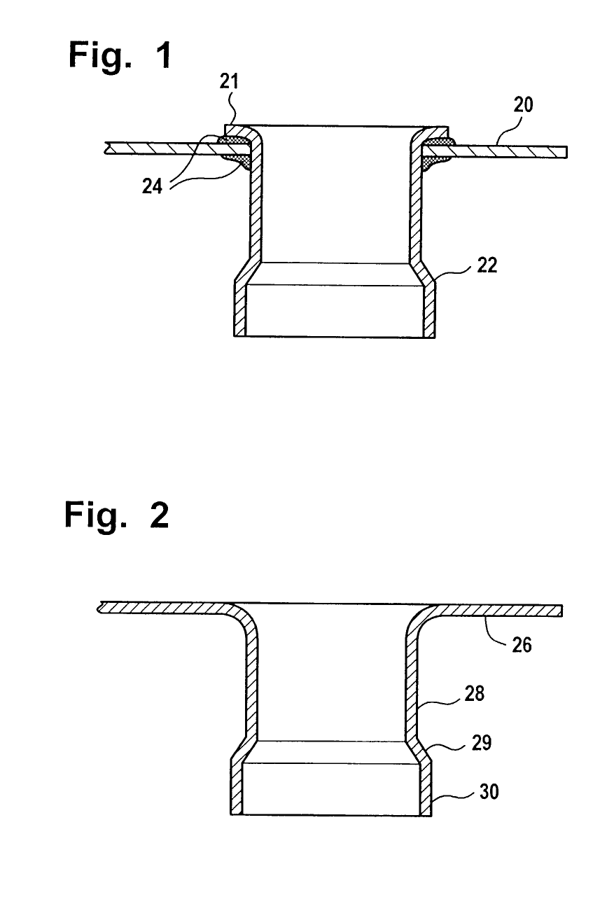

FIG. 1 illustrates a soldered version of the shielding arrangement according to prior art. The arrangement comprises a main shielding enclosure structure 20 that may be 0.5 mm thick, and that is soldered by ring-soldering to an antenna, which has a substantially concentric frame 22, and which may have been standardized according to an ISO standard. As shown, before soldering, the edge 21 of the frame 22 may have been widened by a well known manufacturing step that will cause a certain plastic deforming of the concentric structure. The soldering, although fully feasible in principle, has proved to be a complicating and expensive factor to the manufacture. Next to the typical problems of handling articles at raised temperature, the soldering process itself represents a new process in the workroom of organizations that up to now have been expert mainly in mechanical forming and shaping. Moreover, the maintaining of quality standards is proving to be difficult for the prior art process.

FIG. 2 illustrates an extruded version of the shielding arrangement according to the present invention. Generally, shielding 26 has the same thickness of 0.5 mm as before. However, now antenna 28, 29, 30 has been extruded from the same material as the shielding 26. In one realization, the extrusion did require eight successive steps, which allowed to maintain the strictest requirements for size, positioning, wall uniformity, concentric quality, and smoothness of the transition between the substantially flat shielding 26 and the extruded antenna 28, 29, 30. The concentric frame has a wall thickness of comparable value as the main plate 26. This means that its shape that is more or less a cylinder, is structurally sufficiently rigid for handling, as well as for connecting the external cable or wire. The conical shape of the transition 29 and the tubular sections 28 and 30 allow strictly tolerance-subjected dimensions, wherein the virtual apex of the cone was upward in the Figure as being directed towards the main shielding plate 26. Further processing steps for the manufacture were bending, cutting, punching of the box, connector board-to-board inserting, and finally the inserting from outside of the antenna pin with its plastic holder. The positioning of the antenna pin is done by the extrusion form and two supporting bumps. The location of the board-to-board connector is also effected by one bending operation.

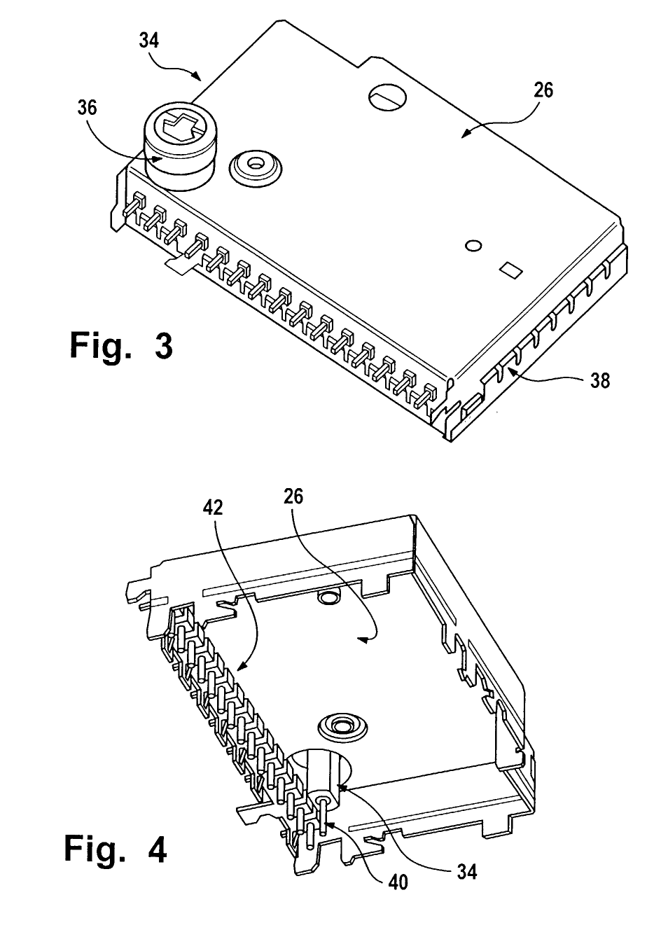

FIG. 3 illustrates an “outside” view of the shielding arrangement according to the present invention. The shielding assembly 26 effectively constitutes the front cover of a box, which as a shielding enclosure is to be combined with a rear cover 38. Their mutual fastening is effected through various tooth-like structures shown more in particular in FIG. 4. Furthermore, item 36 is an ISO-standardized extruded frame antenna, that inside has a plastic contact holder 34. The double-sided cover so realized may be used as a housing for an electronic device or circuit, and in particular for a tuner apparatus. In almost all cases, such electronic circuit will have a shielded signal input as shown in FIGS. 3, 4, and furthermore an output for outputting a user signal such as audio or data.

FIG. 4 illustrates an “inside” view of the shielding arrangement of the present invention, wherein the rear cover 38 of FIG. 3 has been clearly removed for better inspection. Again, assembly 26 fills most of the area, that furthermore carries antenna pin 40 with plastic contact holder 34, and board-to-board connector 42, of which the counterpart is also visible at the lower edge in FIG. 3. Such board-to-board connectors have been the target of extensive standardization operations.

The plastic contact holder locates the antenna pin in the shielding by way of the extruded frame from the shield. The holder is advantageously constructed from ULTRAMID B3 W6G with 30% of glass fiber added. The extruded part comes from pre-tinned band raw material such as DCO4 LC with a thickness of 0.5 millimeter. The eight-step extrusion sequence allowed to reach a height of 14 millimeters with an inside diameter of 9 millimeters. It has been experienced that organizations operational in the stamping business have far more knowledge about steel buckling and similar arts than about soldering processes. A final advantage of the invention is that it allows to maintain an inventory of a single intermediate product, instead of two.

What is claimed is:

1. An electric shielding apparatus, comprising:
a main shielding enclosure structure; and
a generally concentric frame joined to the main shielding enclosure structure, which cooperatively form an electromagnetic radiation shield between an inside electric conductor and an outside space, and which is arranged for mating to an external coaxial conductor via the concentric frame, wherein
the concentric frame is extrusion-formed from the main shielding enclosure structure and comprises a structurally unity with the main shielding enclosure structure.

2. The apparatus as claimed in claim 1, wherein the concentric frame comprises a conically narrowing section that has a virtual apex directed towards the main shielding enclosure structure.

3. The apparatus as claimed in claim 1, wherein the concentric frame has a wall thickness of comparable value as the shielding enclosure structure.

4. The apparatus as claimed in claim 1, wherein the shielding enclosure structure forms a substantially flat base for the concentric frame.

5. The apparatus as claimed in claim 1, wherein the concentric frame houses a polymer contact holder that surrounds an electrical conductor centrally disposed therein.

6. The apparatus as claimed in claim 5, wherein the centrally disposed electrical conductor represents an antenna pin.

7. The apparatus as claimed in claim 1, wherein the shielding apparatus forms a first single-sided cover that is arranged for mating with a second single-sided cover to operate together as a double-sided shielding enclosure.

8. The apparatus as claimed in claim 1, wherein the shielding apparatus forms a first single-sided cover mated with a second single-sided cover to operate together as a double-sided shielding enclosure.

9. The apparatus as claimed in claim 8, wherein the double-sided shielding enclosure as includes an electronic apparatus.

10. The apparatus as claimed in claim 9, wherein the electronic apparatus has a tuner functionality.
